(19) United States
(12) Patent Application Publication
(10) Pub. No.: US 2005/0054403 A1
(43) Pub. Date: Mar. 10, 2005

(54) Apparatus for playing a game

(76) Inventor: Clinton Eng Hiong Lim, Singapore (SG)

Correspondence Address: CONLEY ROSE, P.C., P. O. BOX 3267, HOUSTON, TX, 77253-3267, US

(21) Appl. No.: 10/502,374

(22) PCT Filed: Jan. 23, 2002
(86) PCT No.: PCT/SG02/00010

(51) Int. Cl. A63F 13/00

(52) U.S. Cl. 463/9

(57) ABSTRACT

A game includes a board (10) having a start position (30) and at least two possible finish positions (31). A number of sequential positions (35, 36, 37, 38, 39) are located between the start position (30) and the possible finish positions (31). Each player has a playing piece (21) which starts on the start position (30) and a player designating one of the finish positions (31) prior to starting the game. The game finishing when a player's playing piece (21) lands on the designated finish position (31).

The invention relates to apparatus for playing a game.

In accordance with a first aspect of the present invention, there is provided apparatus for playing a game comprising a board marked substantially as shown in the drawings, and one or more playing pieces, the playing pieces being moved in accordance with directions in the specification.

In accordance with a second aspect of the present invention, there is provided a game comprising a board having a start position and at least two possible finish positions and a number of sequential positions located between the start position and the possible finish positions, each player having a playing piece which starts on the start position, a player designating one of the finish positions prior to starting the game, and the game finishing when a player's playing piece lands on the designated finish position.

Preferably, the sequential positions comprises a number of purchasable positions, at least one of which must be purchased by a player during the game in order for a player to win the game.

Typically, the apparatus may also comprise a set of cards which provide a player with additional instructions. Preferably, a player takes a card when the player's playing piece lands on a corresponding sequential position on the board.

Preferably, there may be more than one set of cards, each set of cards being associated with specified sequential positions of the board such that when a player's playing piece lands on a specified sequential position, the player takes a card from the set of cards corresponding to the specified position.

Typically, the sequential positions are divided into at least two sections, each section corresponding to a level of the game. Preferably, a player must complete the first level before proceeding to the second level. Typically, the start position is on the first level and the possible finishing positions are on the second level.

Typically, the game may be played by two to six players. However, it is possible that it may be played by more than six players.

Preferably, a player's playing piece proceeds round the board by moving the number of places shown by a dice (or die) rolled by the player.

Typically, the layout of the sequential positions on the board depicts the brain with the first level forming the left side of the brain and the second level forming the right side of the brain. Typically, the possible finish positions correspond to desired destiny chosen by a player. Preferably, the purchasable positions in the first level comprise the main functions of the left brain: logic; words; analysis; listing; sequence; linearity; and numbers. Preferably the purchasable positions in the second level comprise the main functions of the right brain: rhythm; colour; dimension; spatial awareness; daydreaming; imagination; and holistic awareness.

In one example of the invention, the game may be implemented using a real physical board and playing piece. However, in another example of the invention, the game may be implemented as an electronic game with the board and playing piece represented on a display device, such as a visual display unit. Where the game also includes cards and money, these may also be electronic and represented on the display device.

In accordance with a third aspect of the invention, there is provided a method of playing a game comprising providing a number of representations of functions of the brain, and acquiring a minimum number of functions in order to win the game.

Preferably, the representations include function of the left side and the right side of the brain, and functions from both sides of the brain must be acquired to win the game.

Typically, a function may be acquired by purchasing the function or by picking up a card relating to the function.

An example of apparatus for playing a game in accordance with the invention will now be described with reference to the accompanying drawings, in which:

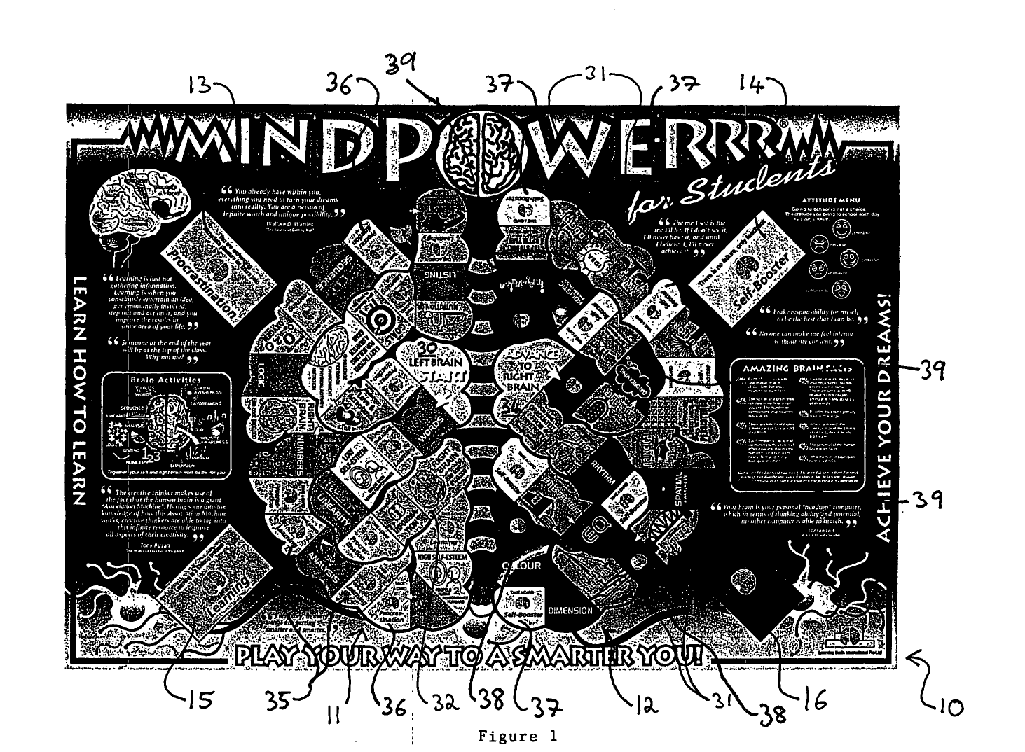

FIG. 1 is a plan view of a board;

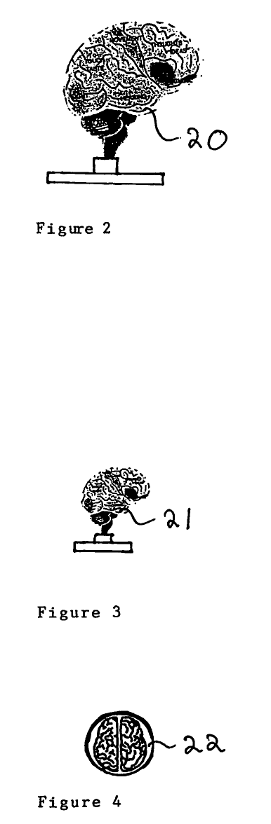

FIG. 2 shows a large brain playing piece;

FIG. 3 shows a small brain playing piece;

FIG. 4 shows a circular brain counter;

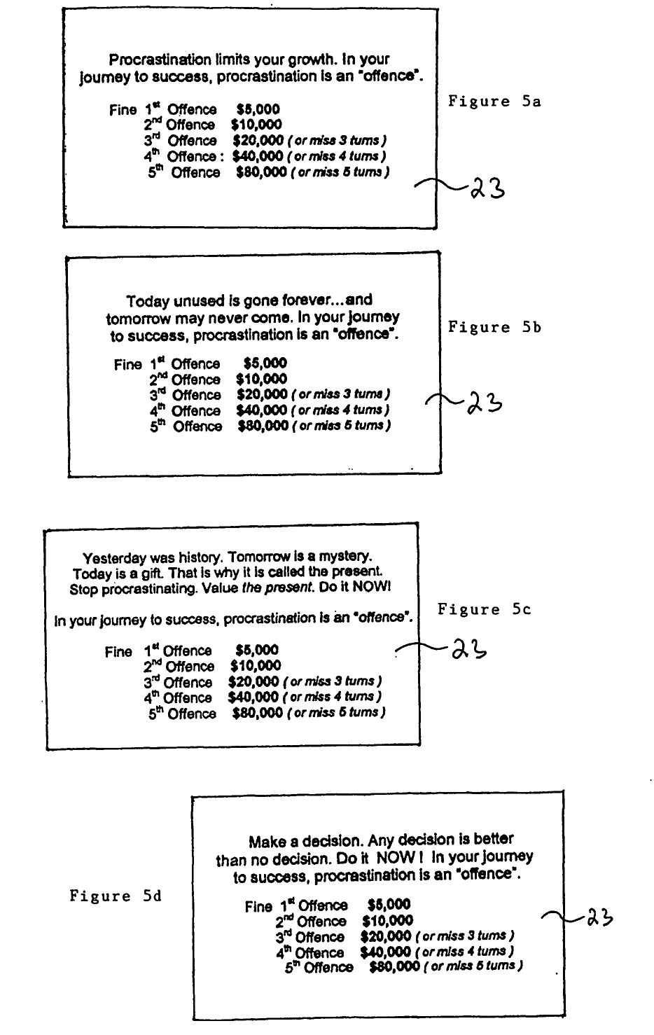

FIGS. 5a to 5d show examples of procrastination cards;

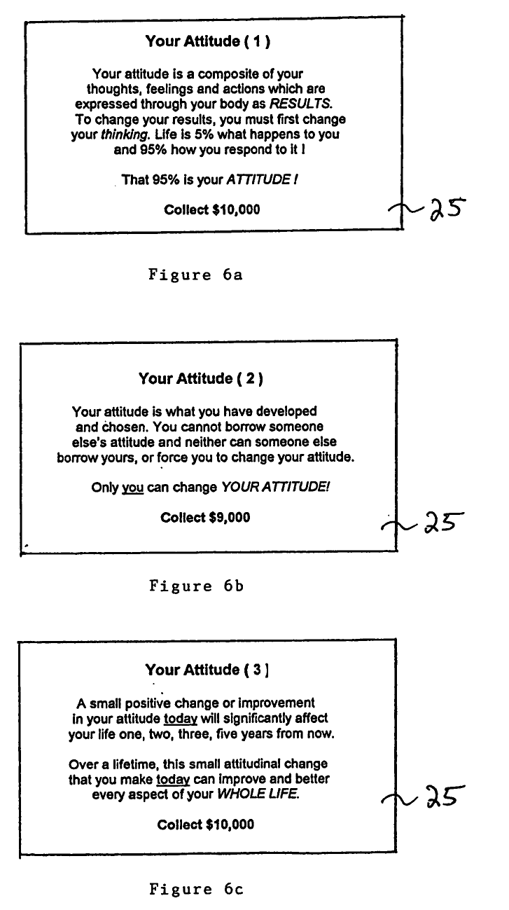

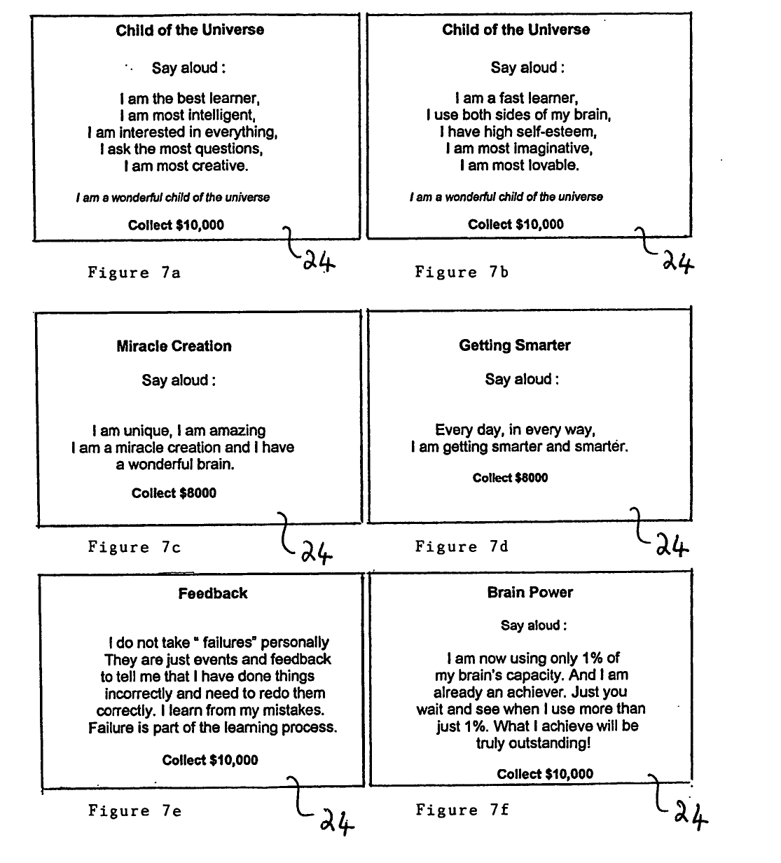

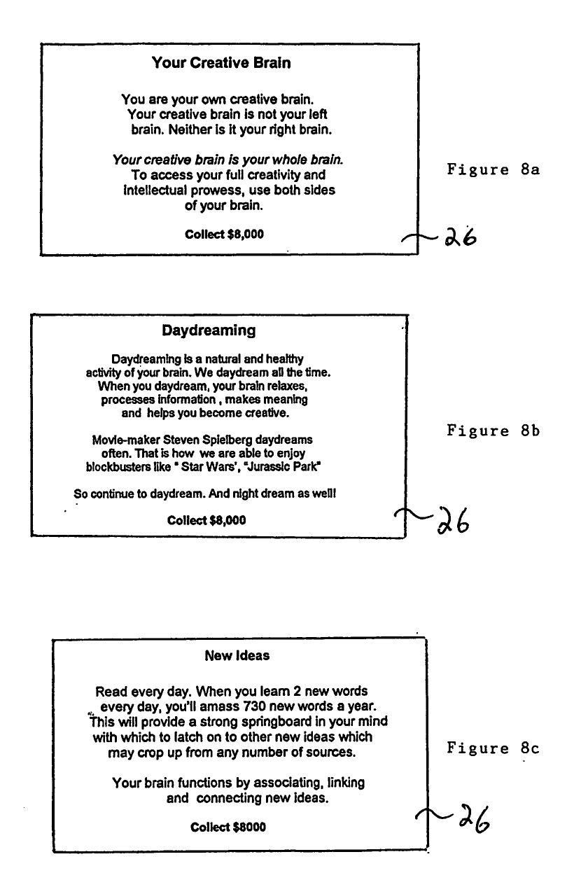

FIGS. 6a to 6c show examples of learning cards;

FIGS. 7a to 7f show examples of self-booster cards; and

FIGS. 8a to 8c show example of synergy cards.

FIG. 1 shows a board 10. The board includes a left brain section 11 and a right brain section 12 which each include sequential positions along which a playing piece 21 (see FIG. 3) can be moved. In addition, the board 10 has positions 13, 14, 15, 16 marked. On each portion 13-16, set of cards 23, 24, 25, 26 may be placed containing additional instructions for players playing the game. A set of procrastination cards 23 are placed on the portion 13, a set of self-booster cards 24 are placed on the portion 14, a set of learning cards 25 are placed on the portion 15 and a set of synergy cards 26 are placed on the portion 16. Examples of procrastination cards 23 are shown in FIGS. 5a to 5d, examples of learning cards 25 are shown in FIGS. 6a to 6c, examples of self-booster cards 24 are shown in FIGS. 7a to 7f and examples of synergy cards 26 are shown in FIGS. 8a to 8c.

In order to play the game, each player is provided with a large brain playing piece 20 (see FIG. 2) and a small brain playing piece 21 (see FIG. 3) and a number of circular brain counters 22 (see FIG. 4). Each of the playing pieces 20, 21 and the counter 22 are of the same colour for each player and each player's colour is different from that of the other players. In addition, each player is provided with $500,000 of play money.

The game is played using the board 10, the playing pieces 20, 21, the circular counters 22 and the sets of cards 13, 14, 15, 16 in accordance with the rules set out below.

Rules

1. Any number, from 2-6 players can play.

2. A “banker” is appointed. A player may double-up as a “banker”.

3. Each player starts with a capital of $500,000 of play money from the banker.

4. The game commences with each player deciding which ambition (or goal in life) they wish from the ambitions 31 on the right brain section 12—doctor, engineer, author, school principal, entertainer, scientist, lawyer, entrepreneur or to achieve financial freedom.

Left Brain

5. Each player chooses two brains 20, 21 of the same colour. The smaller brain is placed at “start” 30 on the left brain 11 and the other larger brain 20 at the site of the chosen ambition 31 on the right brain 12.

6. The challenge is to quickly get out of the “left brain” 11 so that you can advance to play on the “right brain” 12. To do this you must:
i) purchase the “right brain’ site 32 plus any 4 different 7 “left brain” activities 33;
or ii) acquire any 5 different 7 “left brain” activities 33 plus paying $75,000 to the banker.

7. A circular brain counter 22 of the player's colour is placed on each site 32, 33 purchased by a player.

8. A player may purchase as many “right brain” sites 32 as they wish for $100,000 per site, provided that the player stops on it each time and by paying this amount to the banker. If a player does not have sufficient funds, the player may borrow from the banker at an interest rate of 10% per annum, payable upfront (banker issues $90,000 for a $100,000 loan). Debts must be settled in full, before a player can be declared the winner.

9. A player is permitted to sell a “right brain” site 32 (if the player has purchased more than one), to any other player on a “willing-buyer-willing-seller” basis. The maximum amount a player is allowed to charge for it is $200,000.

10. A player may purchase more left brain activity sites 33 than the player requires (at $25,000 each) and then sell the additional sites to another player at a profit not exceeding 100% per site.

11. On stopping at “LEARNING” 35 or “PROCRASTINATION” 36, a player is required to take the appropriate card 25, 23 and follow its instruction before proceeding to collect the reward. Fines are to be paid in cash.

Right Brain

12. A player is permitted to play on the “right brain” 12 provided the player has fulfilled condition 6(i) or 6(ii). When 6(i) or 6(ii) are fulfilled, the small brain playing piece 21 is moved to the “Advance to Right Brain” 34.

13. On stopping at “SELF-BOOSTER” 37 or “SYNERGY” 38, a player is required to take the appropriate card 24, 26 and follow its instructions, before collecting the reward.

14. A player may purchase one or more right brain activity sites 39, and may purchase more sites than the player. Each site 39 is $30,000 each. Excess sites 39 may be sold to another player at a profit not exceeding 100% per site.

15. A circular brain counter 22 of the player's colour is placed on each site 39 purchased by that player.

Declaration of Winner

16. There are three possible ways in which a player may be declared the winner:
i) A player is playing on the right brain and has acquired all seven activities 39:
   rhythm
   colour
   spatial awareness
   dimension
   imagination
   daydreaming
   holistic awareness;
or ii) A player stops on the site 31 of his chosen ambition;
or iii) A player is playing on the right brain and at a prior agreed “stop time”, has amassed the most amount of assets and money.

Although, as described above the game uses a real physical board 10, playing pieces 20, 21, 22, sets of cards 23, 24, 25, 26 and play money, it is possible is that the game could be implemented electronically, for example, using a computer and software. In this case, the board, playing pieces, sets of cards, and play money may be represented on a display coupled to the computer, and the game played by entering appropriate instructions into the computer. For example, the playing pieces may be moved across the board using a mouse or key board.

1. A game comprising a board having a start position and at least two possible finish positions and a number of sequential positions located between the start position and the possible finish positions, each player having a playing piece which starts on the start position, a player designating one of the finish positions prior to starting the game, and the game finishing when a player's playing piece lands on the designated finish position.

2. A game according to claim 1, wherein the sequential positions comprise a number of purchasable positions, at least one of which must be purchased by a player during the game in order for a player to win the game.

3. A game according to claim 1 or claim 2, further comprising a set of cards which provide a player with additional instructions, a player taking a card when the player's playing piece lands on a corresponding sequential position on the board.

4. A game according to claim 3, wherein there are at least two sets of cards, each set of cards being associated with specified sequential positions on the board such that when a player's playing piece lands on a specified sequential position, the player takes a card from the set of cards corresponding to the specified position.

5. A game according to any of claims 1 to 4, wherein the layout of the sequential positions on the board depicts the brain and the possible finish positions correspond to a destiny desired by a player.

6. A game according to any of claims 1 to 5, wherein the sequential positions are divided into at least two sections, each section corresponding to a level of the game.

7. A game according to claim 6, wherein a player must complete the first level before proceeding to the second level.

8. A game comprising a board having a start position and at least two possible finish positions and a number of sequential positions located between the start position and the possible finish positions, each player having a playing piece which starts on the start position, a player designating one of the finish positions prior to starting the game, and the game finishing when a player's playing piece lands on the designated finish position, and wherein the sequential positions are divided into at least two sections, each section corresponding to a level of the game,

9. A game according to claim 8, wherein the layout of the sequential positions on the board depicts the brain and the possible finish positions correspond to a destiny desired by a player.

10. A game according to claim 9, wherein the first level corresponds to the left side of the brain and the second level corresponds to the right side of the brain.

11. A game according to claim 10, wherein the sequential positions comprise purchasable positions, the purchasable positions in the first level comprising the main functions of the left brain: logic; words; analysis; listing; sequence; linearity; and numbers, and the purchasable positions in the second level comprise the main functions of the right brain: rhythm; colour; dimension; spatial awareness; daydreaming; Imagination; and holistic awareness.

12. A method of playing a game comprising providing a number of representations of functions of the brain, and acquiring a minimum number of functions in order to win the game.

13. A method according to claim 12, wherein the representations include functions of the left side and the right side of the brain, and functions from both sides of the brain must be acquired to win the game.

14. A method according to claim 12 or claim 13, wherein a function is acquired by purchasing the function.

15. A method according to any of claims 12 to 14, wherein a function is acquired by picking up a card relating to the function.
